(19) United States
(12) Patent Application Publication
(10) Pub. No.: US 2026/0284996 A1
(43) Pub. Date: Sep. 24, 2026

(54) PRESS DIE DEVICE, UPPER DIE FIXTURE HAVING THE SAME, AND PRESS APPARATUS

(71) Applicant: ALL RING TECH CO., LTD., Kaohsiung City (TW)

(72) Inventor: Tai-Hung LIU, Kaohsiung City (TW)

(21) Appl. No.: 19/301,072

(22) Filed: Aug. 15, 2025

(30) Foreign Application Priority Data
Mar. 24, 2025 (TW) 114202887

(51) Int. Cl. B30B 15/02; B30B 15/14

(52) U.S. Cl. CPC B30B 15/026; B30B 15/148

(57) ABSTRACT

A press die device includes a connecting assembly, a press assembly, a lower fastener, and a temperature sensor. The connecting assembly includes an axial rod formed with an axial hole that extends in an up-down direction, and a bushing sleeved on the axial rod and formed with a bushing hole for extension of the axial rod therethrough. The press assembly is mounted to a bottom end of the axial rod and includes a press seat. The lower fastener is formed with a first channel in spatial communication with the axial hole, and connects the press seat and the axial hole of the axial rod. The temperature sensor extends through the first channel.

### CROSS-REFERENCE TO RELATED APPLICATION

This application claims priority to Taiwanese Utility Model Patent Application No. 114202887, filed on Mar. 24, 2025, the entire disclosure of which is incorporated by reference herein.

### FIELD

The disclosure relates to packaging of an integrated circuit component, and more particularly to a press die device, an upper die fixture having the press die device and a press apparatus for packaging the integrated circuit component.

### BACKGROUND

A conventional press apparatus for packaging an integrated circuit component includes a lower die fixture on which a plurality of to-be-pressed objects are arranged in a matrix, and an upper die fixture movable up and down and cooperating with the lower die fixture to press the to-be-pressed objects. Each of the to-be-pressed objects has a rectangular cross-section, and includes, from bottom to top, a substrate, a chip, a thermal interface material, and a heat sink. The upper die fixture includes a plurality of pressing units that are the same in number with the to-be-pressed objects. Generally, the pressing units respectively press the to-be-pressed objects vertically and downwardly to achieve a relatively good pressing quality, ensuring a relatively good packaging quality in subsequent processes. Each of the pressing units is, for example, a pressing unit disclosed in Taiwanese Invention Patent No. I804790.

The pressing unit disclosed in Taiwanese Invention Patent No. I804790 includes a press die mounted on a bottom of a pressing rod, and a temperature sensor extending through the pressing rod and inserted into a center of the press die to measure a temperature of the to-be-pressed object when the press die is in contact with the to-be-pressed object. Since miniaturization of an integrated circuit component which is to be pressed is an inevitable trend, a size of the press die should be modified accordingly. However, for a press die having a relatively small size, there may be no sufficient space for mounting of a fastener component that interconnects the press die and the pressing rod.

### SUMMARY

Therefore, an object of the present disclosure is to provide a press die device, an upper die fixture, and a press apparatus that can alleviate at least one of the drawbacks of the prior art.

According to an aspect of the disclosure, a press die device includes a connecting assembly, a press assembly, a lower fastener, and a temperature sensor. The connecting assembly includes an axial rod formed with an axial hole that extends in an up-down direction, and a bushing sleeved on the axial rod and formed with a bushing hole for extension of the axial rod therethrough. The press assembly is mounted to a bottom end of the axial rod and includes a press seat. The lower fastener is formed with a first channel in spatial communication with the axial hole, and connects the press seat and the axial hole of the axial rod. The temperature sensor extends through the first channel.

According to another aspect of the disclosure, an upper die fixture includes at least one press die device as described above, and an upper die seat. The upper die seat has at least one mounting area. A number of the at least one mounting area is the same as a number of the at least one press die device. The at least one press die device is mounted to the at least one mounting area. The at least one press die device is connected to the at least one mounting area by the bushing. The axial rod is movable in the up-down direction and drives the press assembly to move relative to the upper die seat in the up-down direction.

According to still another aspect of the disclosure, a press apparatus includes the upper die fixture as described above, and a lower die fixture cooperating with the at least one press die device of the upper die fixture to press at least one to-be-pressed object.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a press die device of an upper die fixture of a press apparatus of an embodiment according to the present disclosure.

FIG. 2 is an exploded perspective view of the press die device.

FIG. 3 is a sectional view taken along line III-III in FIG. 1, illustrating structures of the press die device of the embodiment;

FIG. 4 is a sectional view taken along line IV-IV in FIG. 1, illustrating structures of the press die device.

FIG. 5 is a sectional view taken along line V-V in FIG. 3, illustrating a connecting assembly of the press die device.

FIG. 6 is a perspective view of the press apparatus of the embodiment.

FIG. 7 is a front view of the press apparatus of the embodiment.

FIG. 8 is a partly exploded perspective view of the upper die fixture of the press apparatus of the embodiment.

FIG. 9 is a partly exploded perspective view of the upper die fixture of the embodiment.

FIG. 10 is a fragmentary top view of the upper die fixture.

FIG. 11 is a fragmentary perspective view of a lead frame of the upper die fixture.

FIG. 12 is a sectional view illustrating a fixture driving member of the press apparatus of the embodiment driving downward movement of the upper die fixture so one of the press die devices presses a to-be-pressed object.

FIG. 13 is a sectional view illustrating a press die driver member of the press apparatus driving one of the press die devices to press the to-be-pressed object.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

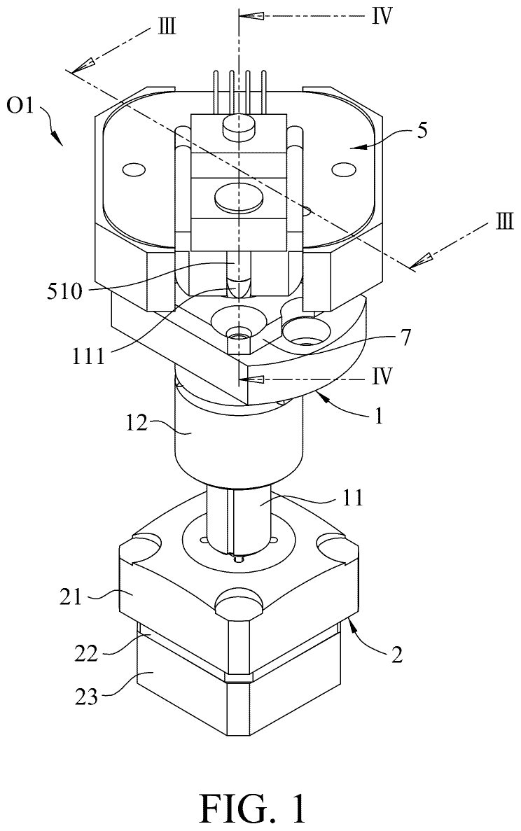

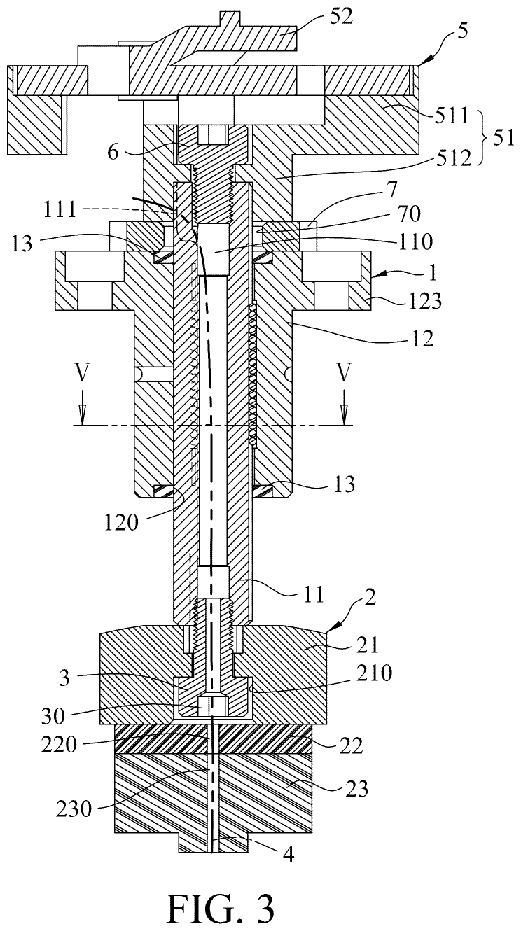

Referring to FIGS. 1 to 3, and 6, a press apparatus (O3) of one embodiment according to the present disclosure includes an upper die fixture (O2) that includes a plurality of press die devices (O1). Since the structures of the press die devices (O1) are identical, only one of the press die devices (O1) (see FIG. 1) will be described in the following for the sake of brevity. The press die device (O1) includes a connecting assembly 1, a press assembly 2 mounted to a bottom portion of the connecting assembly 1, a lower fastener 3 (see FIG. 3) fixedly connecting the connecting assembly 1 and the press assembly 2, a temperature sensor 4 extending through the connecting assembly 1 and the press assembly 2 to the bottom end of the press assembly 2, a pressure detection mechanism 5 mounted on an upper end of the connecting assembly 1, an upper fastener 6 fixedly connecting the connecting assembly 1 and the pressure detection mechanism 5, and a spacer 7 disposed between the connecting assembly 1 and the pressure detection mechanism 5.

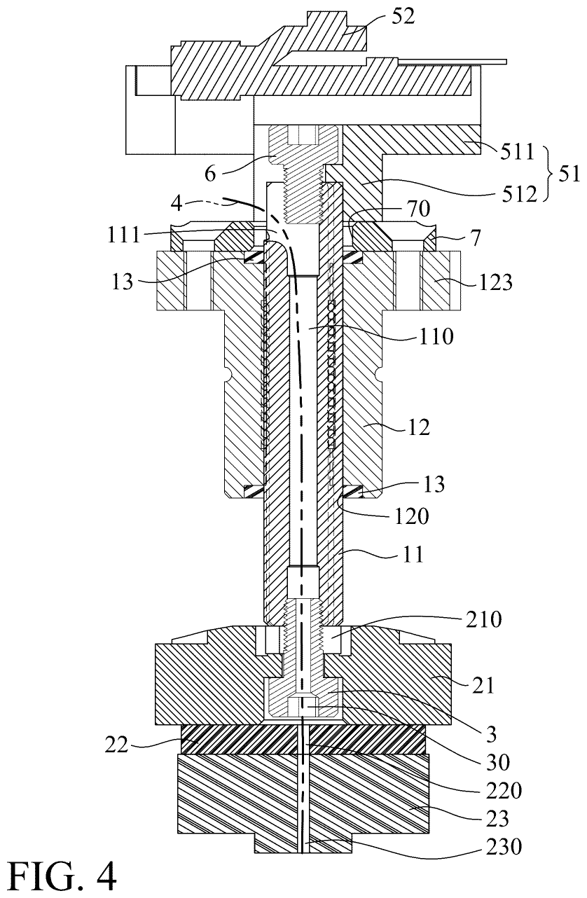

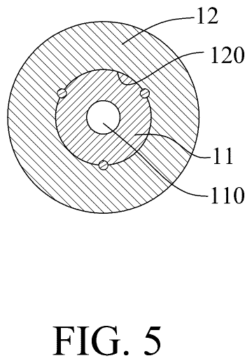

Further referring to FIGS. 3 to 5, the connecting assembly 1 includes an axial rod 11, a bushing 12 sleeved on the axial rod 11, and two sealing rings 13 respectively mounted to top and bottom sides of the bushing 12 in an up-down direction. The axial rod 11 is formed with an axial hole 110 extending in the up-down direction. An upper portion of the axial rod 11 is formed with a slot 111 that is in spatial communication with the axial hole 110. It should be noted that the axial rod 11 is movable in the up-down direction relative to the bushing 12. The bushing 12 is formed with a bushing hole 120 for extension of the axial rod 11 therethrough. In this embodiment, the axial rod 11 and the bushing 12 are in spline connection with each other.

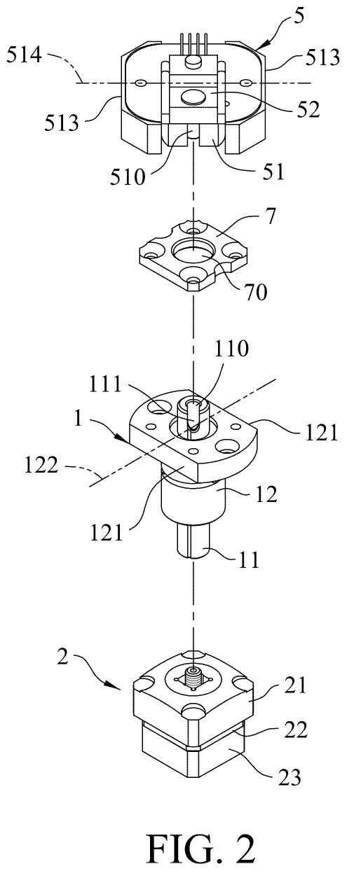

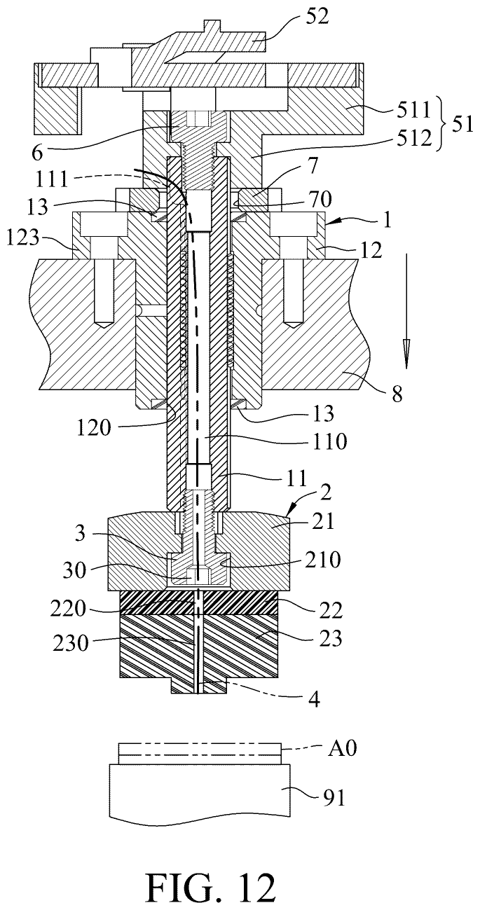

Referring to FIG. 2 to 4, the press assembly 2 is detachably mounted to a bottom end of the axial rod 11, and includes a press seat 21 detachably connected to a bottom portion of the axial hole 110 by the lower fastener 3, a heat insulation element 22 mounted to the press seat 21, and a press die 23 mounted to the heat insulation element 22, and operable to press an to-be-pressed object (A0) (see FIG. 12). The press seat 21 is formed with a lower fastening hole 210 at a center portion thereof for extension of the lower fastener 3 therethrough. In this embodiment, the press die 23 is made of non-metal material and is pressure and temperature resistant. The to-be-pressed object (A0) is, e.g., an integrated circuit component obtained after placement of a heat sink in a semiconductor manufacturing process, and includes, from bottom to top, a substrate, a chip, a thermal interface material, and a heat sink, but the to-be-pressed object (A0) is not limited to this example. In one embodiment, the press seat 21, the heat insulation element 22, and the press die 23 are assembled together with screws.

The lower fastener 3 is formed with a first channel 30 in spatial communication with the axial hole 110. The heat insulation element 22 is mounted to a bottom end of the press seat 21, and is formed with a second channel 220 at a center portion thereof that is in spatial communication with the first channel 30. The press die 23 is connected to a bottom end of the heat insulation element 22, and is formed with a third channel 230 at a center portion thereof that is in spatial communication with the second channel 220. In this embodiment, the bushing hole 120, the axial hole 110, the first channel 30, the second channel 220 and the third channel 230 extend coaxially.

The temperature sensor 4 is configured as a wire, is inserted from an exterior of the axial rod 11 through the slot 111, and extends sequentially through the axial hole 110, the first channel 30, the second channel 220, and the third channel 230 into a bottom end of the press die 23.

The pressure detection mechanism 5 is mounted to the axial rod 11, and includes a support table 51 connected to the upper portion of the axial rod 11, and a pressure sensor 52 mounted to an upper portion of the support table 51. The support table 51 has a support portion 511 on which the pressure sensor 52 is mounted, and a mount portion 512 sleeved on the axial rod 11. A width of the support portion 511 in a left-right direction shown in FIG. 3 transverse to the up-down direction is greater than a width of the mount portion 512 in the left-right direction. The upper fastener 6 extends into and fixedly connects the support table 51 and an upper portion of the axial hole 110. The mount portion 512 is formed with a slit 510 (see FIG. 2) corresponding in position to the slot 111 of the axial rod 11. In this way, the slot 111 is not blocked by the support table 51 when the mount portion 512 of the support table 51 is sleeved on the upper portion of the axial rod 11.

It should be noted that, as shown in FIG. 2, the support table 51 has two first side edges 513 transverse to the up-down direction, parallel to each other, and perpendicular to a first line 514. The bushing 12 has two second side edges 121 transverse to the up-down direction, parallel to each other, and perpendicular to a second line 122. A projection of the first line 514 in the up-down direction on a horizontal plane that is normal to the up-down direction is not parallel to a projection of the second line 122 in the up-down direction on the horizontal plane. In this embodiment, projections of the first line 514 and the second line 122 on the horizontal plane intersect at 45 degrees.

The spacer 7 is disposed between the support table 51 and the bushing 12 in the up-down direction, and is formed with an opening 70 for extension of the axial rod 11 therethrough.

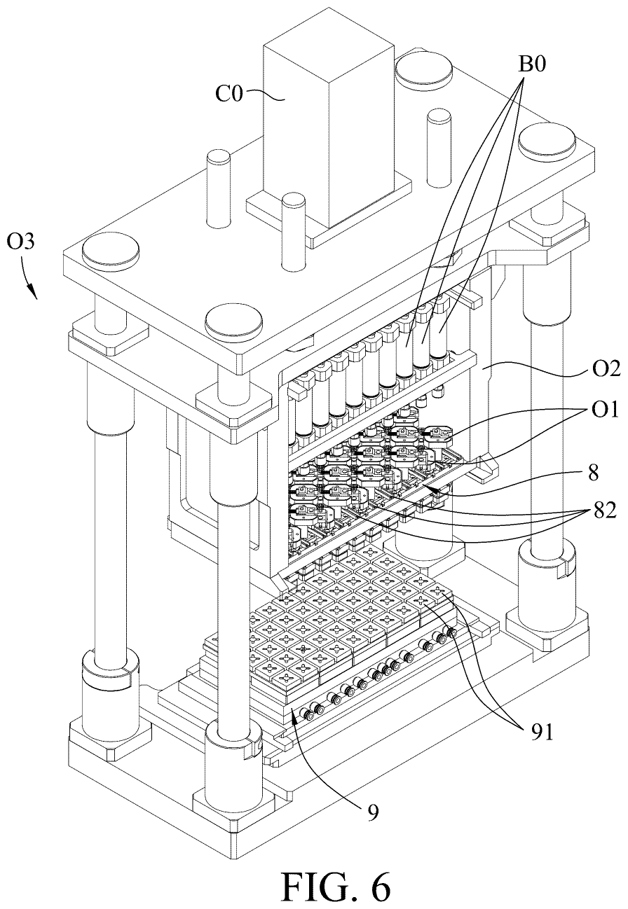

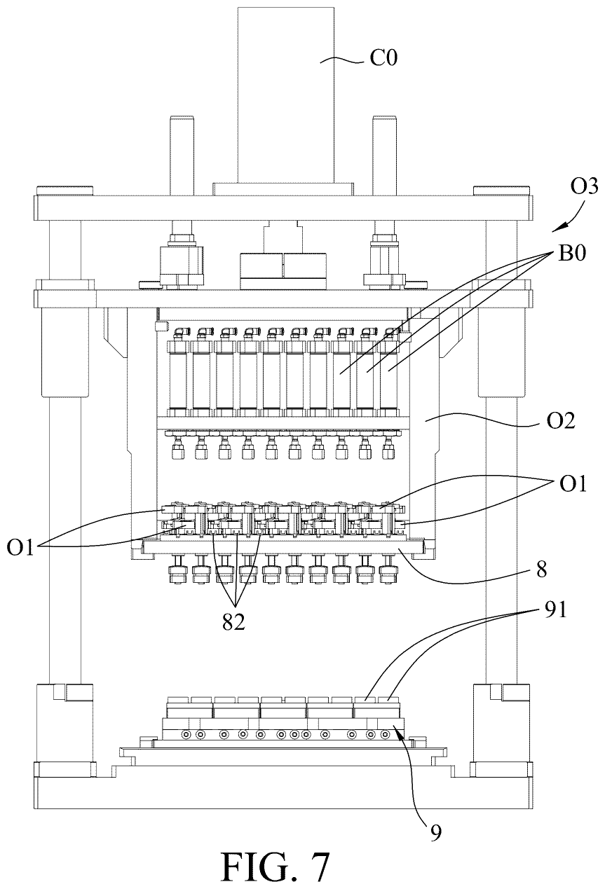

Referring to FIGS. 6 to 8, the upper die fixture (O2) includes fifty of the press die devices (O1) described above, an upper die seat 8 for mounting of the press die devices (O1), and fifty driving components (B0) respectively located above the press die devices (O1) and respectively driving movement of the press die devices (O1) in the up-down direction. The pressure driving components (B0) are, for example, but not limited to, pneumatic cylinder driving components.

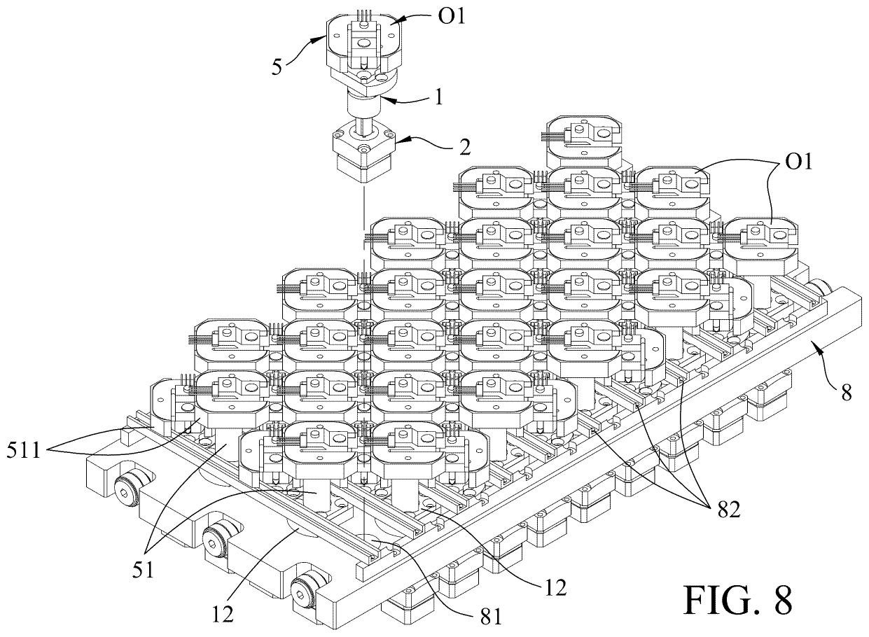

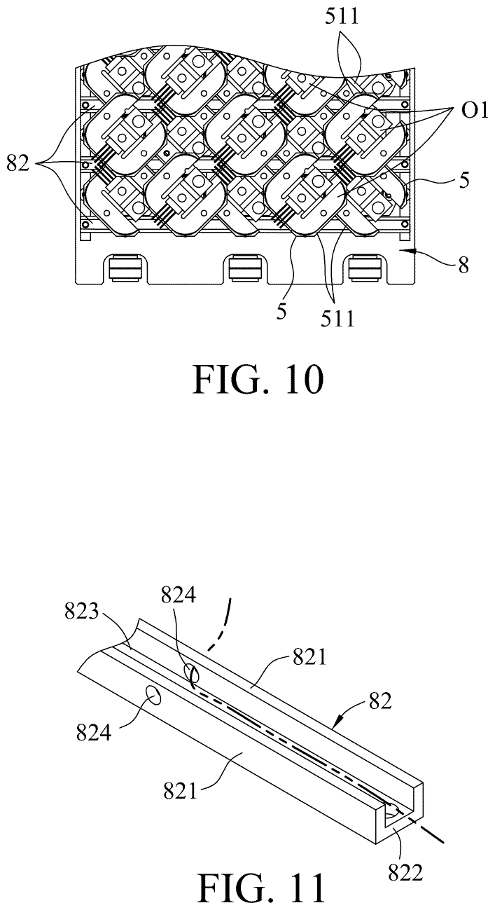

Referring to FIGS. 8 to 10, the upper die seat 8 includes a plurality of mounting areas 81 and a plurality of lead frames 82. The number of the mounting areas 81 is the same as the number of the press die devices (O1) and is fifty in this embodiment. The press die devices (O1) are respectively mounted to the mounting areas 81. The number of the lead frames 82 is eleven, and every two adjacent ones of the lead frames 82 flank five of the mounting areas 81 that are arranged in a row. That is to say, every five of the mounting areas 81 are arranged in a row between two adjacent ones of the lead frames 82. In this embodiment, each of the mounting areas 81 is a through hole extending through the upper die seat 8.

Every five of the press die devices (O1) are arranged in a row between two adjacent ones of the lead frames 82. Each of the press die devices (O1) is connected to the respective one of the mounting areas 81 by the bushing 12 thereof, and is disposed between two adjacent ones of the lead frames 82. It should be noted that two adjacent ones of the press die devices (O1) arranged in a row are located at difference heights in the up-down direction, and any two adjacent ones of the press die devices (O1) are arranged staggered in the up-down direction. In this way, the press die devices (O1) may be densely arranged on the upper die seat 8 in a staggered manner and occupy a relatively small space to minimize an overall size of the upper die seat 8 and the press die devices (O1). As shown in FIGS. 8 to 10, the support portions 511 of the support tables 51 of the pressure detection mechanisms 5 of two adjacent ones of the press die devices (O1) overlap with each other.

Referring to FIGS. 8, 9 and 12, in this embodiment, a procedure of mounting one of the press die devices (O1) to the upper die seat 8 is described below. Since the structures of the press die devices (O1) are identical and the structures of the mounting areas 81 are identical, only one of the press die devices (O1) and the respective one of the mounting areas 81 will be described in the following for the sake of brevity. First, the axial rod 11 and a lower portion of the bushing 12 of the connecting assembly 1 of the press die device (O1) are inserted into the mounting area 81, and the bushing 12 has an upper flange 123 abutting against an upper side of the upper die seat 8 such that the bushing 12 is connected fixedly to the mounting area 81. As such, the upper portion of the axial rod 11 is exposed from the upper side of the upper die seat 8, and a lower portion of the axial rod 11 is exposed from a bottom side of the upper die seat 8. Subsequently, the press assembly 2 of the press die device (O1) is connected fixedly to the axial rod 11 by the lower fastener 3 that extends into the press assembly 2 and the axial rod 11. In this way, the axial rod 11 may drive the press assembly 2 to move therewith in the up-down direction. After the connecting assembly 1 and the press assembly 2 are assembled together, the lead frames 82 are mounted on two spaced-apart racks flanking the ten rows of the mounting areas 81. Finally, the spacer 7 and the pressure detection mechanism 5 are sequentially sleeved on the axial rod 11 to be disposed on the bushing 12 and located above the upper die seat 8.

It should be noted herein that, in other embodiments, the procedure of mounting the press die device (O1) to the upper die seat 8 is not limited to the above description, and may be modified according to actual requirements. For example, the structures and sizes of the mounting area 81, the bushing 12 and the press assembly 2 may be modified and the procedure for mounting the press die device (O1) may be modified accordingly.

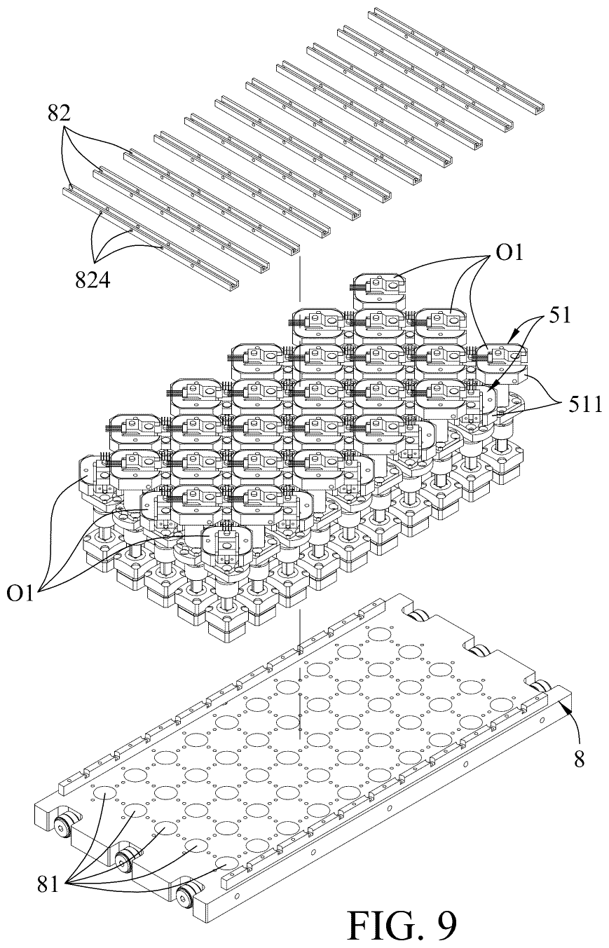

Since the structures of the lead frames 82 are identical, only one of the lead frames 82 will be described in the following. Referring to FIGS. 9 and 11, the lead frame 82 includes two spaced-apart sidewalls 821, and a bottom wall 822 connected to bottom portions of the sidewalls 821. The side walls 821 and the bottom wall 822 cooperatively define a wire slot 823 thereamong. The wire slot 823 is for disposition of electric wires of the temperature sensor 4 and the pressure sensor 52, so the electric wires are neatly arranged and constrained in the wire slot 823. Each of the side walls 821 has a plurality of wire holes 824 (only two is visible in FIG. 11) for extension of the electric wires of the temperature sensor 4 and the pressure sensor 52 so the electric wires may extend outwardly from the wire slot 823 toward the upper die fixture (O2).

Referring to FIGS. 6, 7 and 12, the press apparatus (O3) includes the upper die fixture (O2), a lower die fixture 9 that cooperates with the upper die fixture (O2) to press a plurality of the to-be-pressed objects (A0) (only one is shown in FIG. 12) that are the same in number with the press die devices (O1), and a fixture driving member (C0) that is operable to drive the upper die fixture (O2) to move in the up-down direction, so that the press die devices (O1) of the upper die fixture (O2) may press the to-be-pressed objects (A0), respectively. The press apparatus (O3) is for pressing each of the to-be-pressed objects (A0) that is an integrated circuit component obtained after placement of a heat sink on a chip in a semiconductor manufacturing process. The lower die fixture 9 has a plurality of lower die seats 91 that are the same in number with the press die devices (O1). Each of the lower die seats 91 is provided for the respective one of the to-be-pressed objects (A0) to be disposed thereon. The fixture driving member (C0) is, for example, but not limited to, a pneumatic cylinder driving member. In the following description, since the structures of the to-be-pressed objects (A0) are identical, the structures the lower die seats 91 are identical, and the structures of the press die devices (O1) are identical, only one of the to-be-pressed objects (A0), the respective one of the lower die seats 91 and the corresponding one of the press die devices (O1) will be described for the sake of brevity.

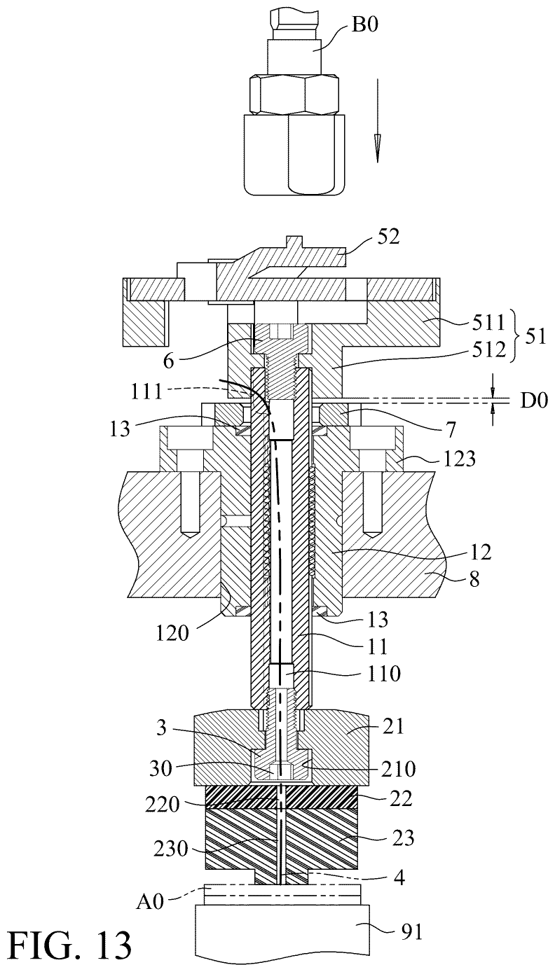

Referring to FIGS. 6, 12 and 13, a procedure of pressing the to-be-pressed object (A0) by the press apparatus (O3) is described in the following. First, the fixture driving member (C0) drives the upper die fixture (O2) to move downwardly toward the lower die fixture 9 in the up-down direction until the press die 23 presses against a top surface of the to-be-pressed object (A0). In this embodiment, since the bushing 12 of the connecting assembly 1 of the press die device (O1) is connected fixedly to the upper die seat 8, and the axial rod 11 is movable in the up-down direction relative to the bushing 12 and the upper fixture seat 8, the axial rod 11 drives the press assembly 2 to move therewith downwardly when the upper die fixture (O2) moves downwardly. When the press assembly 2 is moved downwardly, the press die 23 comes into contact with the top surface of the to-be-pressed object (A0) and the axial rod 11 that is fixedly connected to the pressure detection mechanism 5 by the upper fastener 6 moves slightly and upwardly relative to the upper fixture seat 8 due to a reaction force, creating a gap (D0) (see FIG. 13) between the pressure detection mechanism 5 and the spacer 7. Hereafter, the driving component (B0) presses the pressure detection mechanism 5 downwardly to drive downward movement of the axial rod 11 and to eliminate the gap (D0), then the pressing assembly 2 presses the to-be-pressed object (A0). Thus, packaging of an integrated circuit component is completed after the procedure of pressing the to-be-pressed object (A0) is performed by the press apparatus (O3) of the embodiment of the present disclosure.

It should be noted that, in one embodiment, the upper die fixture (O2) and/or the lower die fixture 9 may include heating modules that heat up the to-be-pressed object (A0) to a predetermined temperature during the procedure of pressing the to-be-pressed object (A0). Since the bottom end of the press die 23 is in contact with the to-be-pressed object (A0) and heat from the to-be-pressed object (A0) is conducted thereto, the temperature sensor 4 extending into the bottom end of the press die 23 may sense a real-time temperature of the to-be-pressed object (A0), and heating power of the heating modules of the upper die fixture (O2) and/or the lower die fixture 9 may be adjusted accordingly.

To sum up, in the embodiment of the present disclosure, by virtue of the lower fastener 3 that connects the connecting assembly 1 and the press assembly 2 and that is formed with the first channel 30 through which the temperature sensor 4 extends, a relatively simple and compact structure of the press die device (O1) may be achieved. In this way, the press apparatus (O3) of the present disclosure is suitable for pressing an integrated circuit component having a relatively small volume and is beneficial in a trend of miniaturization of integrated circuit components.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A press die device, comprising:
a connecting assembly that includes
an axial rod formed with an axial hole that extends in an up-down direction, and
a bushing sleeved on said axial rod and formed with a bushing hole for extension of said axial rod therethrough;
a press assembly that is mounted to a bottom end of said axial rod and that includes a press seat;
a lower fastener that is formed with a first channel in spatial communication with said axial hole, and that connects said press seat and said axial hole of said axial rod; and
a temperature sensor that extends through said first channel.

2. The press die device as claimed in to claim 1, wherein:
said press assembly is detachably connected to said bottom end of said axial rod, and further includes a heat insulation element mounted to said press seat, and a press die mounted to said heat insulation element;
said press seat is formed with a lower fastening hole for extension of said lower fastener thereinto;
said heat insulation element is formed with a second channel in spatial communication with said first channel; and
said press die is formed with a third channel in spatial communication with said second channel.

3. The press die device as claimed in claim 2, wherein said bushing hole, said axial hole, said first channel, said second channel, and said third channel extend coaxially.

4. The press die device as claimed in claim 3, wherein:
said temperature sensor is configured as a wire and extends into said press die through said axial hole, said first channel, said second channel, and said third channel.

5. The press die device as claimed in claim 1, wherein:
an upper portion of said axial rod is formed with a slot in spatial communication with said axial hole; and
said temperature sensor is inserted into said first channel through said slot and said axial hole from an exterior of said axial rod.

6. The press die device as claimed in claim 1, wherein:
said press die device further comprises a pressure detection mechanism mounted on an upper portion of said axial rod.

7. The press die device as claimed in claim 6, wherein:
said pressure detection mechanism includes a support table, and a pressure sensor mounted to an upper portion of said support table.

8. The press die device as claimed in claim 7, wherein:
said support table has a support portion on which said pressure sensor is mounted, and a mount portion sleeved on said axial rod; and
a width of the support portion in a left-right direction transverse to the up-down direction is greater than a width of the mount portion in the left-right direction.

9. The press die device as claimed in claim 7, wherein said press die device further comprises an upper fastener connecting said support table and said the axial hole.

10. The press die device as claimed in claim 7, wherein:
said press die device further comprises a spacer disposed between said support table and said bushing in the up-down direction, and formed with an opening for extension of said axial rod therethrough.

11. The press die device as claimed in claim 7, wherein:
said support table has two first side edges transverse to the up-down direction, parallel to each other, and perpendicular to a first line;
said bushing has two second side edges transverse to the up-down direction, parallel to each other, and perpendicular to a second line; and
a projection of the first line in the up-down direction on a horizontal plane that is normal to the up-down direction is not parallel to a projection of the second line in the up-down direction on the horizontal plane.

12. The press die device as claimed in claim 1, wherein:
said axial rod and said bushing are in spline connection with each other.

13. An upper die fixture, comprising:
at least one press die device as claimed in claim 1; and
an upper die seat that has at least one mounting area, a number of said at least one mounting area being the same as a number of said at least one press die device, said at least one press die device being mounted to said at least one mounting area;
said at least one press die device being connected to said at least one mounting area by said bushing;
said axial rod being movable in the up-down direction and driving said press assembly to move relative to said upper die seat in the up-down direction.

14. The upper die fixture as claimed in claim 13, wherein:
said press assembly is detachably connected to said bottom end of said axial rod, and further includes a heat insulation element mounted to said press seat, and a press die mounted to said heat insulation element;
said press seat is formed with a lower fastening hole for extension of said lower fastener thereinto;
said heat insulation element is formed with a second channel in spatial communication with said first channel; and
said press die is formed with a third channel in spatial communication with said second channel.

15. The upper die fixture as claimed in claim 14, wherein:
said temperature sensor is configured as a wire and extends into said press die through said axial hole, said first channel, said second channel, and said third channel.

16. The upper die fixture as claimed in claim 13, wherein:
said at least one press die device further comprises a pressure detection mechanism mounted on an upper portion of said axial rod; and
said pressure detection mechanism includes a support table, and a pressure sensor mounted to an upper portion of said support table.

17. The upper die fixture as claimed in claim 16, wherein:
said support table has a support portion on which said pressure sensor is mounted, and a mount portion sleeved on said axial rod; and
a width of the support portion in a left-right direction transverse to the up-down direction is greater than a width of the mount portion in the left-right direction.

18. The upper die fixture as claimed in claim 16, wherein said at least one press die device further comprises an upper fastener connecting said support table and said the axial hole.

19. The upper die fixture as claimed in claim 16, wherein:
said support table has two first side edges transverse to the up-down direction, parallel to each other, and perpendicular to a first line;
said bushing has two second side edges transverse to the up-down direction, parallel to each other, and perpendicular to a second line; and
a projection of the first line in the up-down direction on a horizontal plane that is normal to the up-down direction is not parallel to a projection of the second line in the up-down direction on the horizontal plane.

20. A press apparatus, comprising:
said upper die fixture as claimed in claim 13, and
a lower die fixture cooperating with said at least one press die device of said upper die fixture to press at least one to-be-pressed object.
